(19) United States
(12) Patent Application Publication
(10) Pub. No.: US 2026/0008373 A1
(43) Pub. Date: Jan. 8, 2026

(54) VOLTAGE-BASED DISCONNECTION OF ELECTRICAL VEHICLE SUPPLY EQUIPMENT

(71) Applicant: Greentec International Limited, Lichfield Staffordshire (GB)

(72) Inventor: Matthew Hunt, Lichfield Staffordshire (GB)

(73) Assignee: Greentec International Limited, Lichfield Staffordshire (GB)

(21) Appl. No.: 18/880,803

(22) PCT Filed: Jul. 6, 2023
(86) PCT No.: PCT/GB2023/051784

§ 371 Date: Jan. 2, 2025

(30) Foreign Application Priority Data
Jul. 6, 2022 (GB) 2209932.9

(51) Int. Cl. B60L 53/62; B60L 53/30; B60L 53/67; H02H 3/04; H02H 3/14; H02H 3/34

(52) U.S. Cl. CPC B60L 53/62; B60L 53/305; B60L 53/67; H02H 3/04; H02H 3/14; H02H 3/34

(57) ABSTRACT

Electric vehicle supply equipment (100) comprising a detection system (102), wherein the detection system (102) is configured to: create a star point (104) from phases from a multi-phase power source (1); measure (124, 126, 306, 316) a voltage difference between the star point and a neutral conductor (N) or an earth conductor (E); and cause (320) a disconnector (106) to electrically disconnect a vehicle charging interface (208) of the electric vehicle supply equipment (100) from the multi-phase power source (1) in dependence on the voltage difference exceeding a threshold.

### FIELD OF THE INVENTION

Embodiments of the present invention relate to voltage-based disconnection of electric vehicle supply equipment (EVSE). In particular, they relate to EVSE comprising a detection system for voltage-based disconnection of the EVSE.

### BACKGROUND TO THE INVENTION

EVSE is an apparatus configured to supply electrical power for charging plug- in electric vehicles. EVSE is also referred to as a charging station or electric vehicle supply apparatus.

A first type of EVSE, referred to as an AC charging station, supplies alternating current (AC) to the electric vehicle, wherein an on-board charger of the electric vehicle comprises an AC-to-DC converter for providing DC charge to the battery pack of the vehicle.

A second type of EVSE, referred to as a DC charging station, supplies direct current (DC) to the electric vehicle. The EVSE may comprise the AC-to-DC converter.

EVSE can have a single connector for a single-vehicle, or a plurality of connectors so that a plurality of vehicles can charge simultaneously.

If a three-phase electrical power source is available from the electricity supply network, the EVSE will receive three live phases L1, L2, L3 each carried by a separate live conductor. The EVSE will also receive a neutral conductor and an earth conductor (PE, Protective Earth). Three-phase AC charging is faster than single-phase AC charging.

Depending on the electrical distribution network, an earthing system of the three-phase electrical power source will either be TN or TT as defined in IEC 60364. Note: In the United States and Canada, ‘earth’ is referred to as ‘ground’.

In a TN earthing system, the earth connection is supplied by the electricity supply network, either through the neutral conductor (TN-S earthing system), through the earth conductor (TN-C earthing system), or both (TN-C-S earthing system). In a TN earthing system, the body of the customer electrical device is connected to a remote earth electrode at the transformer of the electricity supply network, through one of these conductors.

A TN earthing system is effective, provided that the neutral conductor is functioning. If the neutral conductor is broken on the supply side, there is no longer a reference voltage for the three phases. If the load between phases is unbalanced (which it invariably is because there will be different loads on each phase), the voltage difference between phases can become substantial, causing a potential electrocution risk through the neutral conductor at the customer side. Residual Current Devices (RCDs, also known as Ground Fault Interrupters, GFIs) would not be able to detect the break if the network is TN-C or TN-C-S. An RCD will not detect an open neutral event as the live and neutral are still balanced even though the earth conductor may be live.

In a TT earthing system, an additional earth connection is provided in the form of a local earth electrode at the customer electrical device. Therefore, a break in a conductor at the supply side does not cause the local earth conductor to become live.

Due to the high voltages and currents involved in EVSE equipment, EVSE installers are generally required by national technical standards, such as the NEC code for the United States of America, to install a local earth electrode specifically for the EVSE, or utilise an existing local earth electrode if one is available at the site. This requirement is regardless of whether the earthing system of the electricity supply network is TN or TT.

Therefore, in an open Neutral event (e.g., broken neutral conductor), the EVSE can rely on the local earth electrode having sufficient resistance to blow a fuse to disconnect the supply.

National technical standards consider it necessary and sufficient to install a local earth electrode for the EVSE.

BRIEF DESCRIPTION OF VARIOUS EMBODIMENTS OF THE INVENTION

The inventors of the present application have identified that the mere installation of a local earth electrode for the EVSE may not be a sufficient long- term or maintenance-free solution. For example, the local earth electrode may degrade over time, especially due to corrosion. The most common type of earth electrode is a steel-cored earth rod with a thin copper coating. If the copper coating is damaged, the steel will be exposed and may rapidly corrode in the presence of ground moisture.

Due to the lower ground moisture levels in summer than in winter, the resistance of a degrading earth rod may become unacceptably high in the summer. This can result in inconsistent earthing performance throughout the year.

Further, local earth electrodes can be inadvertently disconnected unintentionally.

If the neutral conductor breaks while the local earth electrode is disconnected or has a high resistance, a user of the EVSE may receive an electric shock if they touch their car while the car is plugged into the EVSE.

Even if the local earth electrode is functioning, an open neutral may force return current to flow from the local earth electrode, through the earth, back to the transformer of the electricity supply network. This can result in a ground potential rise that can cause stray voltages on earthed surfaces.

Therefore, according to an aspect of the invention there is provided electric vehicle supply equipment comprising a detection system, wherein the detection system is configured to:
create a star point from phases from a multi-phase power source;
measure a voltage difference between the star point and a neutral conductor or an earth conductor; and
cause a disconnector to electrically disconnect a vehicle charging interface of the electric vehicle supply equipment from the multi-phase power source in dependence on the voltage difference exceeding a threshold.

An advantage is that the electric vehicle supply equipment offers improved electrical fault protection. The loss of any one of the phases, or the neutral, would cause a voltage difference between the star point and the neutral conductor. Likewise, an elevated earth potential would cause a voltage difference between the star point and the earth conductor.

According to another aspect of the invention, there is provided a method of monitoring an electric vehicle supply equipment fault, the method comprising:
measuring a voltage difference between a star point created from a multi-phase power source, and either a neutral conductor or an earth conductor; and
causing a disconnector to electrically disconnect a vehicle charging interface of electric vehicle supply equipment from the multi-phase power source in dependence on the voltage difference exceeding a threshold.

### BRIEF DESCRIPTION OF THE DRAWINGS

For a better understanding of various examples of embodiments of the present invention reference will now be made by way of example only to the accompanying drawings in which:

FIG. 1 illustrates an electrical circuit diagram of an example of EVSE comprising a detection system;

FIG. 2 illustrates an example of a control system; and

FIG. 3 illustrates a flowchart of an example method.

### DETAILED DESCRIPTION OF VARIOUS EMBODIMENTS OF THE INVENTION

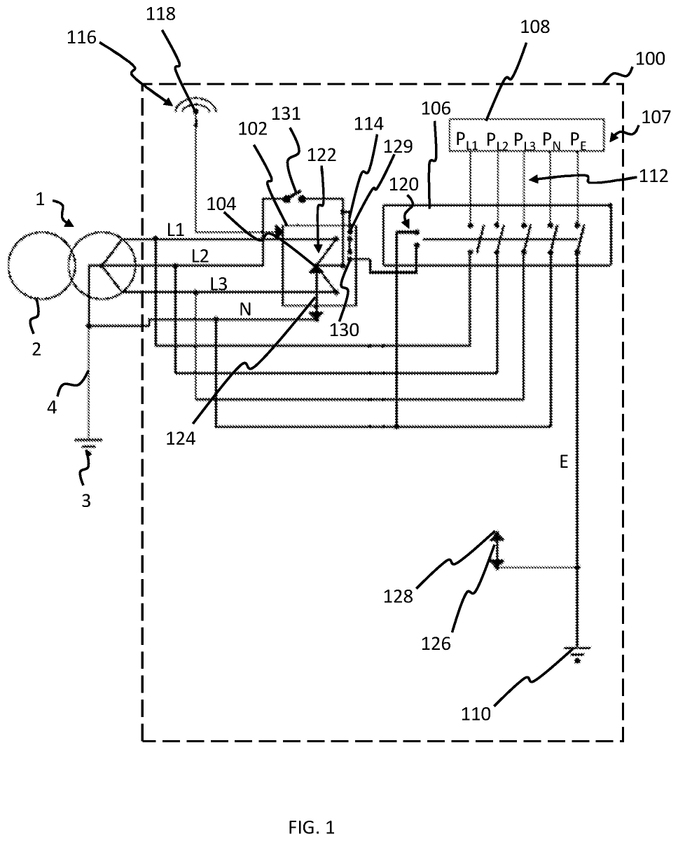

In FIG. 1, the electrical components within the dashed-line box of FIG. 1, labelled 100, represent components of the EVSE 100. Components outside the dashed-line box represent supply side components.

According to some, but not necessarily all examples, a multi-phase power source 1 from the electricity supply network for the EVSE 100 is a three-phase power source, as shown in FIG. 1. The multi-phase power source 1 comprises three phases, represented by distribution conductors, L1, L2, L3 connecting to an input 101 of the EVSE 100. In the United States of America, the conductors L1-L3 may be referred to as A, B, C.

The three phases L1, L2, L3 are connected to a supply transformer 2 and a remote earth electrode 3. The remote earth electrode 3 is a supply earth electrode, remote from the EVSE 100 and separated from the EVSE 100 by the distribution distance from the EVSE 100 which may be tens of metres to kilometers or more. The remote earth electrode 3 can comprise an earth rod, for example.

The supply transformer 2 may connect the phase conductors L1, L2, L3 in a star configuration, also referred to as a Wye configuration.

The centre of the star configuration of the supply transformer 2 is earthed via a remote earth conductor 4. The remote earth conductor 4 connects the centre of the star configuration of the supply transformer 2 to the remote earth electrode 3.

The multi-phase power source 1 further comprises a neutral conductor N connected to the input 101 of the EVSE 100. The neutral conductor N is connected to the centre of the star configuration of the supply transformer 2. In FIG. 1, the neutral conductor N is connected to the remote earth conductor 4.

FIG. 1 shows no separate distribution earth conductor connecting the remote earth electrode 3 to the input 101 of the EVSE 100. However, in other examples, the EVSE 100 may receive a distribution earth conductor separate from the distribution neutral conductor N.

The input 101 of the EVSE 100 in FIG. 1 is connected to the distribution conductors L1, L2, L3, N. The conductors extend through the EVSE 100 as local conductors.

FIG. 1 shows the illustrated EVSE 100 comprising one charging point 107, although in other examples the EVSE 100 may comprise additional charging points 107.

The charging point 107 comprises a vehicle charging interface 108 for connecting to a charging system of an electric vehicle (whether a battery electric vehicle or a hybrid electric vehicle). The vehicle charging interface 108 is in the form of a vehicle charging contactor/outlet.

In some examples, the EVSE 100 may comprise a plurality of charging points 107, each comprising a vehicle charging interface 108, to enable simultaneous charging of multiple vehicles.

The vehicle charging interface 108 can comprise a charging socket, to which a user can connect their own plug. Alternatively, the vehicle charging interface 108 can comprise a charging plug at the end of a charging cable 112 of the EVSE 100.

In some examples, the vehicle charging interface 108 is a standardised connector as defined in IEC 62196 such as a Type 2 connector, or as defined in other technical standards.

The vehicle charging interface 108 shown in FIG. 1 is an AC charging interface. The AC charging interface is a contactor comprising a first pin P_{L1} for phase L1, a second pin P_{L2} for phase L2, a third pin P_{L3} for phase L3, a fourth pin P_{N} for the neutral conductor N, and a fifth pin P_{E} for a local earth conductor E. This pinout enables three-phase AC charging.

Although not illustrated, the vehicle charging interface 108 may further comprise additional pins, such as one or more pins for signalling conductors. A Type 2 connector comprises a pin for a Proximity Pilot conductor, and a pin for a Control Pilot conductor.

If the EVSE 100 comprises an AC-to-DC converter (not shown), the vehicle charging interface 108 may additionally or alternatively comprise one or more DC pins, each for a DC conductor.

The local earth conductor E is connected at one end to the PE pin of the vehicle charging interface 108 and at another end to a local earth electrode 110 such as a local earth rod. The EVSE 100 comprises the local earth electrode 110. The local earth electrode 110 may be added by the EVSE installer. The term ‘local’ in this context means a supplementary earth electrode for the EVSE 100. The local earth electrode 110 may be just for the EVSE 100 or may be shared by other local services than the EVSE 100.

One local earth electrode 110 may serve either one vehicle charging interface 108 or a plurality of vehicle charging interfaces 108. Each vehicle charging interface 108 may be served by the same local earth electrode 110 or by different local earth electrodes 110.

The earth conductor E of the EVSE 100 of FIG. 1 is local only and unconnected to the remote earth electrode 3. However, in other TN-S or TN-C-S implementations, the earth conductor E of the EVSE 100 may be connected to a distribution earth conductor and therefore to the remote earth electrode 3.

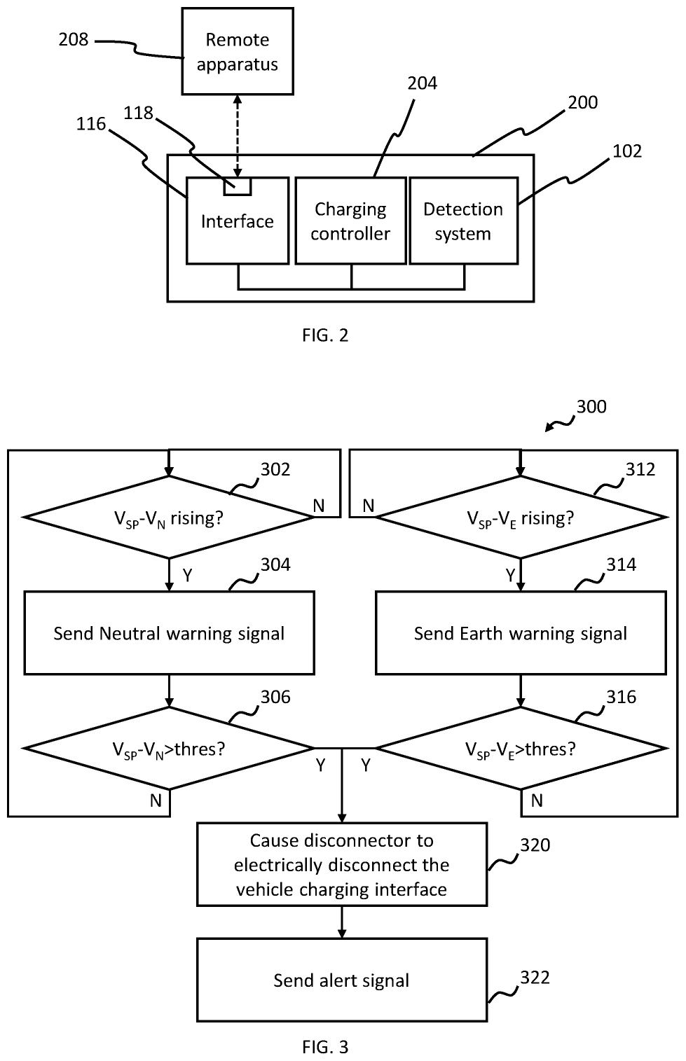

FIG. 2 illustrates an example control system 200 for controlling functions of the EVSE 100. The control system 200 comprises an electric vehicle charging controller 204. The electric vehicle charging controller 204 can be implemented as a printed circuit board comprising any appropriate circuitry, for example.

The electric vehicle charging controller 204 can comprise operational circuitry including one or more of: load management circuitry (e.g., to prevent exceedance of a current limit); charging contactor monitoring circuitry (e.g., to detect a connection to an electric vehicle); charging status display control circuitry; and communication control circuitry for a communication interface 116 of the EVSE 100.

The control system 200 may comprise a master control unit for all of the one or more vehicle charging interfaces 108. The control system 200 may comprise individual control units, each for one of several vehicle charging interfaces 108.

According to an aspect of the invention, the EVSE 100 comprises a detection system 102 and a disconnector 106, between the input 101 of the EVSE 100 and the vehicle charging interface 108.

The illustrated detection system 102 is configured to detect a neutral fault condition relating to the neutral conductor N and is separately configured to detect an earth fault condition relating to the earth conductor E, and as a consequence cause the disconnector 106 to disconnect the vehicle charging interface 108 from the multi-phase power source 1. In other examples, the detection system 102 only detects the neutral fault condition or the earth fault condition.

The disconnector 106 is in the form of a circuit breaker comprising a shunt trip 120. The shunt trip 120 may comprise a five-pole shunt trip, to simultaneously open L1, L2, L3, N, and E. Advantageously, E is disconnected at substantially the same time as the live conductors L1-L3.

The disconnector 106 may be automatic, for example the shunt trip 120 may be actuated via a relay controlled by the detection system 102. The shunt trip 120 may be actuated via a magnetic field of a coil.

The disconnector 106 may be energised by a live conductor 114 connected to one of the phases (L2 in FIG. 1), wherein the live conductor 114 contains two contacts 129 and 130 in series. These contacts 129, 130 are normally closed during a healthy supply. If the neutral fault condition is satisfied, the contact 129 is opened which in turn causes the disconnector 106 to disconnect the vehicle charging interface 108 from the multi-phase power source 1. If the earth fault condition is satisfied, the contact 130 is opened which in turn causes the disconnector 106 to disconnect the vehicle charging interface 108 from the multi-phase power source 1.

The illustrated arrangement of normally-closed contacts 129, 130 in series represents a Boolean OR condition for the two monitored fault conditions: if any one of the conditions is satisfied, disconnection is effected. However, it would be appreciated that the contacts 129, 130 could be arranged differently to achieve the same effect.

The illustrated detection system 102 is upstream of the disconnector 106 so remains always powered by the multi-phase power source 1 regardless of the state of the disconnector 106. The detection system 102 may comprise a power supply connected to one of the phases such as.

The vehicle charging interface 108 is downstream of the disconnector 106, as well as the charging cable 112 (if present), and AC-to-DC converter (if present).

It is desirable for the detection system 102 to have a fast response time, reacting immediately to a fault. Therefore, as shown in FIG. 1, the detection system 102 is configured to create a star point 104 from the multi-phase power source 1. At the detection system 102, a connection is made into each of the three live conductors (phases L1, L2, L3) and tied together in a star (Wye) configuration 122 creating the star point 104 at the centre of the star 122.

The detection system 102 may branch off from the conductors L1, L2, L3, N to read conductor voltages, such that electrical power flowing through the EVSE 100 to the electric vehicle bypasses the detection system 102. As shown in FIG. 1, each conductor L1, L2, L3, N branches in the EVSE 100, with one branch extending to the detection system 102 and the other branch extending to the disconnector 106.

To detect a fault condition relating to the neutral conductor N, the detection system 102 is configured to measure a voltage difference between the star point 104 and the neutral conductor N. This measurement can be made by any appropriate voltage sensor 124.

If the voltage difference exceeds a predetermined neutral threshold, the detection system 102 causes the disconnector 106 to disconnect the vehicle charging interface 108 from the multi-phase power source 1. For example, the detection system 102 may open the contact 130, connecting the shunt trip 120 to one of the phases such as L2 to energise the shunt trip 120.

The voltage difference can exceed the neutral threshold if all three of the following conditions are simultaneously true: (1) the neutral conductor N is broken upstream of the disconnector 106; (2) the load between phases L1, L2, L3 is unbalanced; and (3) the local earth conductor E is high-resistance or open circuit (e.g., due to corrosion or disconnection of the local earth electrode 110).

This detection provides a level of fallback protection so that the EVSE 100 is not wholly reliant on a reliable, low-resistance local earth connection to trip a fuse in the event of a neutral fault. The ability to detect the neutral fault is not compromised by a broken connection to the local earth electrode 110 because the detection system 102 detects the voltage difference without reference to the earth conductor E.

To detect a fault condition relating to the earth conductor E, the detection system 102 is configured to measure a voltage difference between the star point 104 and the earth conductor E. This measurement can be made by any appropriate voltage sensor-see FIG. 1 in which a voltage sensor 126 connects a starpoint terminal 128 to the earth conductor E, wherein the starpoint terminal is at the electric potential of the star point 104 (i.e., connected to the centre of the star configuration 122).

If the voltage difference exceeds a predetermined earth threshold, the detection system 102 causes the disconnector 106 to disconnect the vehicle charging interface 108 from the multi-phase power source 1. For example, the detection system 102 may open the contact 130, connecting the shunt trip 120 to one of the phases such as L2 to energise the shunt trip 120.

An advantage of this additional earth check is the ability to check imported voltages from the earth, also referred to as an elevated earth potential.

In order for a user to charge their electric vehicle via the vehicle charging interface 108, both measurements must be less than the associated threshold.

In an example implementation, the neutral threshold is in the order of tens of volts, such as more than 30 volts or more than 40 volts. In an example implementation, the earth threshold is in the order of tens of volts, such as more than 30 volts or more than 40 volts. 50 volts AC or greater is generally considered to be a touch voltage limit, but some vulnerable users may be at- risk from lower voltages. In an implementation, the neutral threshold is approximately 70 volts and/or the earth threshold is approximately 70 volts. These example thresholds have the same value, but could alternatively have different values (e.g., 20 volts apart). The specific threshold values may vary from country to country/grid to grid.

Initiating the disconnection may be dependent on a time-of-exceedance of the relevant threshold (neutral and/or earth). For example, the detection system 102 may comprise a timer configured to start upon initiation of exceedance of the relevant threshold, wherein the detection system 102 is configured to initiate the disconnection in response to the timer reaching a predetermined time. The predetermined time may be no greater than one second. The predetermined time may be no less than 40 milliseconds. The predetermined time may be dependent on the voltage difference, for example: 70 v=1 sec, 100 v=0.7 sec,200 v=0.2 sec and 400 v=0.04 sec. The predetermined time(s) for the neutral threshold may differ from the predetermined time(s) for the earth threshold.

In FIG. 1, a manual test input 131, such as a manual test switch, is provided to manually cause the detection system 102 to register an above-threshold voltage difference and initiate the disconnection. The manual test input 131 is manually operable to cause a loss of one of the three phases at the star 122. Manually operating the manual test input 131 may comprise opening the switch. This phase loss will shift the voltage of the star point 104 to the midpoint between the remaining two phases, being 115 volts on a 230 volt system. This would cause the detection system 102 to initiate the disconnection because the voltage difference is over the relevant threshold. This is an effective way of checking that the system is functional.

As shown in FIG. 2, the detection system 102 can form part of the control system 200. For example, the detection system 102 may be integrated on the same printed circuit board as the electric vehicle charging controller 204. The detection system 102 may be within a same enclosure as the electric vehicle charging controller 204. The detection system 102 may share the power supply with the electric vehicle charging controller 204. The detection system 102 may share the communication interface 116 with the electric vehicle charging controller 204.

In other examples, functions of the control system 200 may be distributed across a plurality of separate controllers. Implementation of a controller may be as controller circuitry. The controller may be implemented in hardware alone, have certain aspects in software including firmware alone or can be a combination of hardware and software (including firmware).

One or more of the following components of the EVSE 100 may receive their power supply upstream of the disconnector 106 or via separate means, and therefore remain operational after the disconnector 106 has disconnected the vehicle charging interface 108: the control system 200; the detection system 102; the electric vehicle charging controller 204; the communication interface 116; a charging status display or other visual/audio output device (not shown) of the EVSE 100.

The communication interface 116 of FIG. 2 can comprise any appropriate wired or wireless communication interface. The communication interface 116 may be configured to send signals and/or information to a remote apparatus 208 such as a server and/or a computer/mobile device. The remote apparatus 208 may be separated from the EVSE 100 by a wide area communication network such as the Internet.

The manner in which the communication interface 116 communicates with the remote apparatus 208 may be via a telecommunications standard, such as short-message-service, or via Internet Protocol, e-mail, and/or any other appropriate communication standards.

The communication interface 116 may comprise a radio frequency transmitter 118 or transceiver. The radio frequency transmitter 118 may be operable in a GHz band. The radio frequency transmitter 118 may be compatible with wireless local area network standards (e.g., Wi-Fi), wireless personal area network standards (e.g., Bluetooth), and/or wireless telecommunication standards (e.g., 3GPP standards).

In some examples, telemetry may be sent to the remote apparatus 208 via the communication interface 116. For example, the detection system 102 may be configured to continuously or periodically or conditionally send information dependent on the measured voltage difference between the star point 104 and the neutral conductor N. Additionally, or alternatively, the detection system 102 may be configured to continuously or periodically or conditionally send information dependent on the measured voltage difference between the star point 104 and the earth conductor E.

The information may be timestamped. The information may comprise diagnostic data. The diagnostic data may indicate a time history of the measured voltage difference(s). The information may be presented graphically to a user of the remote apparatus 208. The telemetry may comprise a live feed. Spikes in the voltage difference(s) may be automatically flagged via an appropriate timestamp. Sending telemetry information enables remote inspection of spikes or upwards drift in the voltage differences, where they should be substantially zero.

In some, but not necessarily all examples, the control system 200 and/or detection system 102 may be away from a main housing of the EVSE 100, the main housing providing the vehicle charging interface 108. For example, the control system 200 may be an indoor unit and/or master unit that may communicate with one or more disconnectors 106 via wired or wireless communication, for example via the communication interface 116. Similarly, the control system 200 may be in a separate enclosure than the disconnector 106. Alternatively, the main enclosure may contain the control system 200 and/or detection system 102.

FIG. 3 illustrates a flowchart of a method 300. The method 300 may be implemented by at least part of the control system 200, such as the detection system 102.

The method 300 includes the above-described detection methods for detecting neutral and earth faults, and additional optional blocks relating to an early warning system.

The method 300 may be performed regardless of whether the vehicle charging interface 108 is connected to an electric vehicle or not. The method 300 may be performed substantially continuously. Advantageously, this means that the vehicle charging interface 108 can be automatically disconnected without anyone present, so that the vehicle charging interface 108 is isolated by the next time a user arrives to charge their vehicle.

Decision block 302 comprises determining whether a neutral warning condition is satisfied, associated with the neutral conductor N. Satisfaction of the neutral warning condition depends on the voltage difference between the star point V_{SP} and the neutral conductor V_{N} rising towards the neutral threshold.

For example, a lower threshold than the neutral threshold may be set for this early warning, having a value at least 10 volts or at least 20 volts below the main neutral threshold. The value is high enough to indicate a potential problem with the neutral conductor N.

If the neutral warning condition is satisfied, the method 300 proceeds to block 304 which comprises sending a neutral warning signal. Sending the neutral warning signal can comprise causing the communication interface 116 to send a message indicative of the satisfaction of the neutral warning condition. The message may be sent to the remote apparatus 208. For example, an e-mail or short message (SMS) may be sent to the remote apparatus 208. Additionally, or alternatively, a timestamped flag may be applied to the telemetry to indicate when the neutral warning condition was satisfied.

This enables an engineer to be dispatched before the fault reaches a level where the EVSE 100 becomes non-operational. This is advantageous because at the time of writing, the installation of EVSE 100 lags behind the purchases of electric vehicles, so it is important to minimise any EVSE downtime.

The next decision block 306 comprises determining whether the voltage difference between the star point V_{SP} and the neutral conductor V_{N} exceeds the neutral threshold. In some examples, initiating the disconnection may be dependent on the time-of-exceedance of the neutral threshold.

If block 306 is satisfied, the method 300 proceeds to block 320 which causes the disconnector 106 to electrically disconnect the vehicle charging interface 108 from the multi-phase power source 1.

The disconnector 106 may be only manually resettable and within a locked enclosure, to ensure that no reset is possible until an engineer or other authorised user has attended to the underlying fault even if the fault is only transient. In an example, the disconnector 106 can comprise a lever or reset button. In some examples, the disconnector 106 may be remotely resettable, for example for remote testing of the shunt trip 120 over the Internet, for example in response to remote signals via a communication interface such as the communication interface 106.

If block 306 is satisfied, block 322 may also be carried out (may be after block 320). Block 322 comprises sending an alert signal indicating that the disconnector 106 is caused (will be/has been caused) to electrically disconnect the vehicle charging interface 108 of the EVSE 100 from the multi-phase power source 1. Sending the alert signal can comprise causing the communication interface 116 to send a message indicative of the exceedance of the neutral threshold. The message may be sent to the remote apparatus 208. For example, an e-mail or short message (SMS) may be sent to the remote apparatus 208. This enables an engineer to be dispatched to fix the problem, to minimise any EVSE downtime.

In another implementation, the alert signal and/or the warning signals are transmitted to a local apparatus or local visual output device of the EVSE 100, without being sent to a remote apparatus 208.

Decision block 312 comprises determining whether an earth warning condition is satisfied, associated with the earth conductor E. Satisfaction of the earth warning condition depends on the voltage difference between the star point V_{SP} and the earth conductor V_{E} rising towards the earth threshold.

For example, a lower threshold than the earth threshold may be set for this early warning, having a value at least 10 volts or at least 20 volts below the main earth threshold. The value is high enough to indicate a potential problem with the earth conductor E.

If the earth warning condition is satisfied, the method 300 proceeds to block 314 which comprises sending an earth warning signal. Sending the earth warning signal can comprise causing the communication interface 116 to send a message indicative of the satisfaction of the earth warning condition. The message may be sent to the remote apparatus 208. For example, an e-mail or short message (SMS) may be sent to the remote apparatus 208. Additionally, or alternatively, a timestamped flag may be applied to the telemetry to indicate when the earth warning condition was satisfied.

The next decision block 316 comprises determining whether the voltage difference between the star point V_{SP} and the earth conductor V_{E} exceeds the earth threshold. In some examples, initiating the disconnection may be dependent on the time-of-exceedance of the earth threshold.

If block 316 is satisfied, the method 300 proceeds to blocks 320 and 322 as described above. The alert signal of block 322 may indicate the reason for the disconnection: earth fault or neutral fault, depending on which threshold w as exceeded.

Sending the neutral warning signal can comprise causing the electric vehicle charging controller 204 to control a visual output device of the EVSE 100 (if the EVSE 100 has one), such as a display,

The blocks illustrated in FIG. 3 may represent steps in a method and/or sections of code in a computer program. The illustration of a particular order to the blocks does not necessarily imply that there is a required or preferred order for the blocks and the order and arrangement of the block may be varied. Furthermore, it may be possible for some steps to be omitted.

The skilled person would understand that the terms ‘connect’ and ‘disconnect’ used herein mean ‘electrically connect/disconnect’ as opposed to ‘physically connect/disconnect’.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. Electric vehicle supply equipment comprising a detection system, wherein the detection system is configured to:
create a star point from phases from a multi-phase power source;
measure a voltage difference between the star point and a neutral conductor or an earth conductor; and
cause a disconnector to electrically disconnect a vehicle charging interface of the electric vehicle supply equipment from the multi-phase power source in dependence on the voltage difference exceeding a threshold.

2. The electric vehicle supply equipment of claim 1, wherein the detection system is configured to send an alert signal indicating that the disconnector is caused to electrically disconnect the vehicle charging interface of the electric vehicle supply equipment from the multi- phase power source.

3. The electric vehicle supply equipment of claim 1, wherein the voltage difference is between the star point and the neutral conductor, and wherein the detection system is further configured to send a Neutral warning signal in dependence on the voltage difference satisfying a condition associated with the voltage difference increasing towards the threshold.

4. The electric vehicle supply equipment of claim 1, wherein the voltage difference is between the star point and the earth conductor, and wherein the detection system is further configured to send an Earth warning signal in dependence on the voltage difference satisfying a condition associated with the voltage difference increasing towards the threshold.

5. The electric vehicle supply equipment of claim 1, wherein the voltage difference is between the star point and the neutral conductor, and wherein the detection system is further configured to:
measure a second voltage difference, between the star point and the earth conductor; and
cause the disconnector to electrically disconnect the vehicle charging interface from the multi-phase power source in dependence on the second voltage difference exceeding a second threshold.

6. The electric vehicle supply equipment of claim 5, wherein the second threshold has the same value as the threshold or is a value within 20 volts of the threshold.

7. The electric vehicle supply equipment of claim 1, wherein the threshold has a value in the order of tens of volts.

8. The electric vehicle supply equipment of claim 1, wherein the earth conductor is configured to electrically connect the vehicle charging interface to a local earth electrode via the disconnector.

9. (canceled)

10. The electric vehicle supply equipment of claim 1, wherein the vehicle charging interface is a vehicle charging contactor, wherein the vehicle charging contactor comprises three pins for three phases of the multi-phase power source, a fourth pin for the earth conductor, and a fifth pin for the neutral conductor, wherein the first to fifth pins are electrically connected to an output of the disconnector.

11. (canceled)

12. The electric vehicle supply equipment of claim 1, comprising a control system including an electric vehicle charging controller for electrical load management of the vehicle charging interface, and the detection system, and further comprising a main enclosure containing the control system and the detection system.

13. The electric vehicle supply equipment of claim 1, comprising a communication interface, wherein the detection system is configured to send information dependent on the measured voltage difference between the star point and the neutral conductor or earth conductor.

14. The electric vehicle supply equipment of claim 13, wherein the communication interface comprises a radio frequency transmitter.

15. The electric vehicle supply equipment of claim 13, wherein the information includes diagnostic data indicating a time history of the measured voltage difference.

16. The electric vehicle supply equipment of claim 1, wherein the detection system is configured to initiate the electrical disconnection in dependence on a time-of-exceedence of the threshold.

17. The electric vehicle supply equipment of claim 1, comprising a manual test input, manually operable to cause the voltage threshold to exceed the threshold.

18. (canceled)

19. The electric vehicle supply equipment of claim 1, wherein the star point is created by the detection system connecting to each of three phases of the three-phase power source, and tying the three phases together in a star configuration, wherein the star point is at a centre point of the star configuration.

20. The electric vehicle supply equipment of claim 1, comprising a plurality of charging points each comprising a vehicle charging interface, wherein the detection system is configured to cause the disconnector to disconnect the plurality of vehicle charging interfaces in dependence on the voltage difference exceeding the threshold, wherein the electric vehicle supply equipment comprises a control system comprising a master control unit for the plurality of vehicle charging interfaces, and wherein the control system includes load management circuitry for electrical load management of the plurality of vehicle charging interfaces.

21. A method implemented by a control system, of monitoring an electric vehicle supply equipment fault, the method comprising:
measuring a voltage difference between a star point created from a multi-phase power source, and either a neutral conductor or an earth conductor; and
causing a disconnector to electrically disconnect a vehicle charging interface of electric vehicle supply equipment from the multi-phase power source in dependence on the voltage difference exceeding a threshold.

22-25. (canceled)

26. The electric vehicle supply equipment of claim 16, wherein the detection system comprises a timer configured to start upon initiation of exceedance of the threshold, wherein the detection system is configured to initiate the electrical disconnection in response to the timer reaching a predetermined time, and wherein the predetermined time decreases in dependence on the voltage difference increasing.

27. The electric vehicle supply equipment of claim 16, wherein the voltage difference is between the star point and the neutral conductor, and wherein the detection system is further configured to:
measure a second voltage difference, between the star point and the earth conductor; and
cause the disconnector to electrically disconnect the vehicle charging interface from the multi-phase power source in dependence on the second voltage difference exceeding a second threshold,
wherein the detection system comprises a timer configured to start upon initiation of exceedance of the second threshold, wherein the detection system is configured to initiate the electrical disconnection in response to the timer reaching a predetermined time, and wherein the predetermined time for the threshold differs from the predetermined time for the second threshold.
